(19) United States
(12) Patent Application Publication
(10) Pub. No.: US 2024/0045415 A1
(43) Pub. Date: Feb. 8, 2024

(54) METHOD FOR AUTOMATED ERROR HANDLING OF A PRODUCTION PLANT, AND PRODUCTION PLANT

(71) Applicant: SOMIC VERPACKUNGSMASCHINEN GMBH & CO. KG, Amerang (DE)

(72) Inventor: Christoph Kögel, Prutting (DE)

(21) Appl. No.: 18/366,132

(22) Filed: Aug. 7, 2023

(30) Foreign Application Priority Data
Aug. 8, 2022 (DE) 10 2022 119 867.7

(51) Int. Cl. G05B 23/02

(52) U.S. Cl. CPC G05B 23/0262; G05B 2223/02

(57) ABSTRACT

A method comprising a plurality of image acquisition units and a plurality of error detection units at a production plant. The production plant comprises a plurality of work zones, each of which are assigned at least one of the image acquisition units and at least one of the error detection units. A control unit is configured to detect a signal of at least one of the error detection units and based on this detection detect whether an error in the production plant has occurred in the work zone to which the error detection unit is assigned. When the control unit detects an error in a work zone, it provides image data from at least one image acquisition unit of that work zone to a user via an output unit. The invention also relates to a production plant using this method.

The present invention relates to a method for automated error handling of a production plant, and to a corresponding production plant.

In general, production plants are known in which the occurrence of errors can be detected by suitable devices, and the production plant can thus be stopped immediately, for example. However, it has been shown that, in the case of an error which has occurred, a considerable time investment must be expended for the error analysis, in order to retrospectively reconstruct the circumstances under which and the reason for which a respective error has occurred.

It is therefore the object of the present invention to provide a method for automated error handling of a production plant, and/or a correspondingly configured production plant, in order to simplify the error analysis, as well as an optimization based thereon of the production plant.

In a first aspect, this object is achieved according to the present invention by a method for automated error handling of a production plant, comprising the following steps:
providing a plurality of image acquisition units and a plurality of error detection units at a production plant, wherein the production plant comprises a plurality of work zones, each of which is assigned at least one of the image acquisition units and at least one of the error detection units,
providing a control unit which is configured to detect a signal of at least one error detection unit and to detect, based thereon, whether an error in the production plant has occurred in the work zone to which the error detection unit is assigned, and,
in the event that an error has been detected in a work zone, forwarding image data which are and/or have been detected by the at least one image acquisition unit of this work zone to a user, using an output unit.

In this way, a user, e.g., a developer of the production plant or a service employee, can be provided in an automated manner with the image data which show the work zone in which the error has been detected. In this way, a reconstruction and retroactive analysis of the error can be significantly reduced or even completely omitted, since the error analysis can take place on the basis of the provided image data. In particular, a time stamp correlating with the image data can be generated following a signal from the error detection unit that an error has been detected, said time stamp indicating at what point in time in the recorded image data the error occurred.

An image acquisition unit can comprise a camera, for example. The camera can in particular be configured to detect light in the spectrum visible to humans and/or outside this spectrum, e.g., in the range of X-ray radiation, and to generate image data based thereon. In the event that a work zone is assigned more than one image acquisition unit, the image data generated by the respective image acquisition unit can be provided to the user via the output unit in a separated and/or combined manner—for example, as what is known as “image-in-image” image data.

Advantageously, the image data of a respective image acquisition unit can be stored in a circular buffer, wherein image data are overwritten by new image data after a predetermined time period has elapsed. Using a circular buffer makes it possible to ensure that image data are also available for the past, i.e., for a predetermined time period before an error occurs. Particularly in production plants having a high throughput of the same production goods, it is possible to determine that causes which lead to an error in the production plant are usually not longer ago than a predetermined period of time, such that correspondingly older image data can remain disregarded for the error analysis.

For this reason, the predetermined time period may be at most 1 hour, in particular at most 15 minutes, and, advantageously, approximately 5 minutes.

In this context, the image data, which are provided automatically to the user via the output unit in the event of an error, can comprise image data which were recorded up to the predetermined time period before the point in time at which the error was detected in the work zone. In relation to the above-mentioned values, given by way of example, for the predetermined time period, it may thus be possible to analyze image data which have been recorded up to 1 hour, in particular up to 15 minutes, and, advantageously, up to 5 minutes, before the occurrence of an error. Based upon this, the occurrence of an error can already be analyzed in an initial stage, and thus the cause of an error can be found in a simplified manner.

In this case, the image data, which are provided in an automated manner to the user by the output unit in the event of an error, can comprise image data which have been recorded 0.3 min to 1.5 min, and in particular 0.5 min, before the time at which the error has been detected in the work zone, wherein image data are provided at the output unit, following input by a user, which have been recorded more than 0.3 min to 1.5 min, and in particular more than 0.5 min, before the time at which the error has been detected in the work zone. In other words, the method can be configured such that, although stored image data are available which have been recorded more than 0.3 min to 1.5 min, and in particular 0.5 min, before the time at which the error in the work zone has been detected, the step of automated provision of the image data in the event of an error provides only image data at the output unit which have already been recorded 0.3 min or more, advantageously up to 1.5 min, and in particular 0.5 min, before the time at which the error has been detected in the work zone. The background for this is that it has been found that, in most cases of error, a retrospective analysis of about 0.3 min to 1.5 min, and in particular of 0.5 min, before the error event is sufficient to be able to determine the cause of the error. Only in a small number of errors may it be necessary to analyze image data which have been recorded more than 0.3 min to 1.5 min, and in particular more than 0.5 min, before the error occurred. As a result, analytical effort can be further reduced.

The user can, for example, make an input at the output unit himself, by which he requests image data which have been recorded more than 0.3 min to 1.5 min, and in particular more than 0.5 min, before the time at which the error has been detected in the work zone. For this purpose, it may be conceivable both for such a request by a user to be assigned a fixed, predetermined time period for which image data before the error occurrence are provided, e.g., 10 minutes, and also for the user to be enabled to set the predetermined time period by his request, e.g., from 1 minute to 1 hour, in minute steps.

In advantageous developments of the present invention, an identification of the work zone in which the error has occurred can also be provided, together with the image data which are provided to the user via the output unit. In this way, the user can very quickly identify the work zone in which the error has occurred. The identification of the work zone can comprise at least one letter and/or at least one digit, which uniquely identify/identifies the work zone.

In particular, each image acquisition unit and each work zone can be assigned a unique identifier, and the identifier of the work zone in which the error has occurred and the identifier of each image acquisition unit assigned to this work zone can be provided to the user via the output unit. As an example, corresponding information which is provided to the user via the output unit can be designed as a multi-digit identifier which comprises (for example, four) identifiers of the corresponding work zone and (for example, three) identifiers of the camera by which the provided image data have been recorded.

Furthermore, the image data, which are provided to the user via the output unit in the event of an error, can be automatically transmitted to a memory unit, from which the image data can be permanently retrieved. That is to say that each time an error in the production plant has been detected, the corresponding image data can be stored in a permanent memory unit, such that a database of errors having associated image data can be created. During transfer into the permanent memory unit, the image data can comprise image data which have been recorded for a predetermined time period, e.g., 5 minutes, and in particular the maximum available time period, before the occurrence of the error. The image data can comprise the aforementioned additional information, such as an identification of the work zone and/or an identification of the image acquisition unit which has generated the image data, and/or an identification of the error detection unit which has detected the error in the production plant.

The control unit can be assigned a database in which predefined error texts are stored, wherein the predefined error texts are assigned to at least one error type—in particular, to a combination of error detection unit and work zone. This makes it easier for a user to identify which error has occurred in which work zone.

In one example, a particular work zone can be assigned an identifier “0403,” wherein it is possible for the descriptive text, “gantry cover head,” to be assigned to the work zone or the identifier “0403.” If, by way of example, a further error now occurs, in which a corresponding torque, which is exerted on a production item in the work zone, does not correspond to a predetermined torque, this error can be assigned the identifier “056” and/or the error text, “torque horizontal.” When the image data are output at the output unit, in the event of an error, the above information can be output in a combined manner—for example, as “torque gantry cover head horizontal 0403056.”

Furthermore, it should be mentioned here that the software, which is designed to carry out the method according to the invention, can have a corresponding data interface to general production plant software and/or to operating software of the production plant. Alternatively, the software for carrying out the method according to the invention can also be integrated into the production plant as part of the operating software of said production plant.

In a further aspect, the object mentioned at the outset is achieved according to the present invention by a production plant which is designed to handle errors in an automated manner—in particular, using the method according to the invention—said production plant comprising
a plurality of image acquisition units and a plurality of error detection units, wherein the production plant comprises a plurality of work zones, each of which is assigned at least one of the image acquisition units and at least one of the error detection units,
a control unit, which is configured to detect a signal of at least one error detection unit and to detect, based thereon, whether an error in the production plant has occurred in the work zone to which the error detection unit is assigned, and
wherein the control unit is further configured, in the event that an error has been detected in a work zone, to forward image data, captured by the at least one image acquisition unit of this work zone, to a user, via an output unit.

It should already be pointed out here that all of the features, effects, and advantages mentioned in relation to the method according to the invention can also be applied to the production plant according to the invention, and vice versa.

For example, the output unit can be provided at the production plant. Alternatively or additionally, it is of course conceivable for the image data and/or the further information to be transmitted to a remote output unit, such as a computer having a screen and input device, or a tablet.

The output unit can furthermore be configured to receive user inputs, wherein in particular the output unit is designed as a touchscreen. Thus, a user can make inputs directly at the output unit—for example, request image data having an earlier recording time and/or image data of another image acquisition unit or another work zone.

According to advantageous developments of the present invention, the production plant can comprise functional units which can be mechanically and/or electrically connected to one another, wherein each functional unit has exactly one work zone. The individual functional units can have, in particular, mutually standardized interfaces, such that a production plant can be formed in a modular manner by combining a plurality of functional units.

In this case, each functional unit can be provided with a unique identifier, wherein the identifier of the functional unit in which an error has been detected is output to the user via the output unit together with the image data. With reference to the example already mentioned above, the identifier, “0403,” can be assigned to a specific functional unit having the work zone, “gantry cover head.”

An image acquisition unit can be configured to detect image data via only the functional unit or a work zone assigned to this functional unit, or can be configured to also detect image data of an adjacent functional unit or at least one adjacent work zone. In this context, it should be pointed out that an image acquisition unit which is assigned to a work zone of a functional unit does not necessarily have to be arranged on the same functional unit, but can also be attached separately therefrom—for example, on an adjacent functional unit of the production plant.

An error detection unit may comprise at least one of a light barrier, a pressure sensor, a current acquisition unit, and a magnetic field unit. A current acquisition unit can, for example, be configured to detect a current intensity and/or a voltage which is/are delivered to a work zone or which is/are consumed by elements of the work zone. From this, it is possible to infer, for example, a torque which is currently applied to a production item by a corresponding element of the work zone. In the event that the currently detected torque deviates from a predetermined torque, an error detection can be output by the error detection unit. A magnetic field unit can, for example, be configured to detect changes in a magnetic field and thus, in particular, determine the presence/absence of magnetizable materials, which may have been unwantedly introduced into production goods.

The invention will be described in greater detail in the following, with reference to the accompanying drawings, in which:

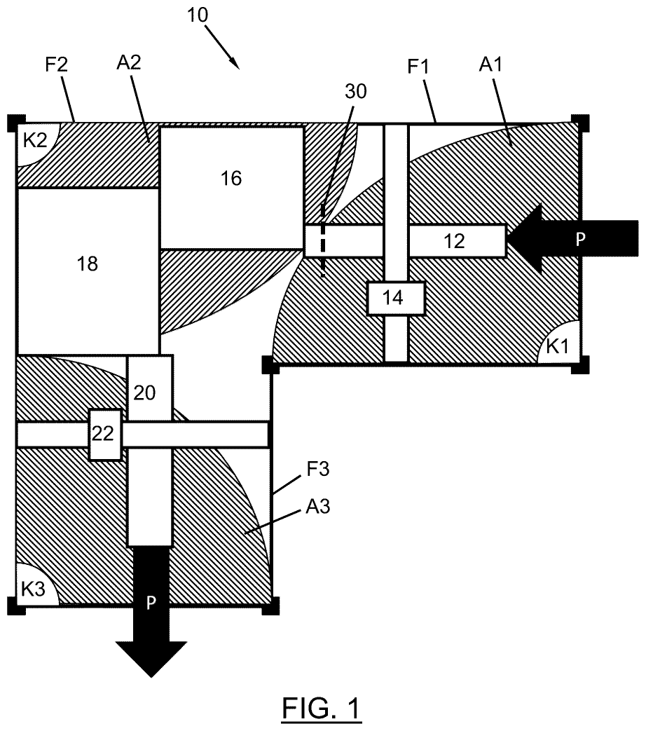

FIG. 1 shows a production plant according to the invention with schematically drawn working elements; and

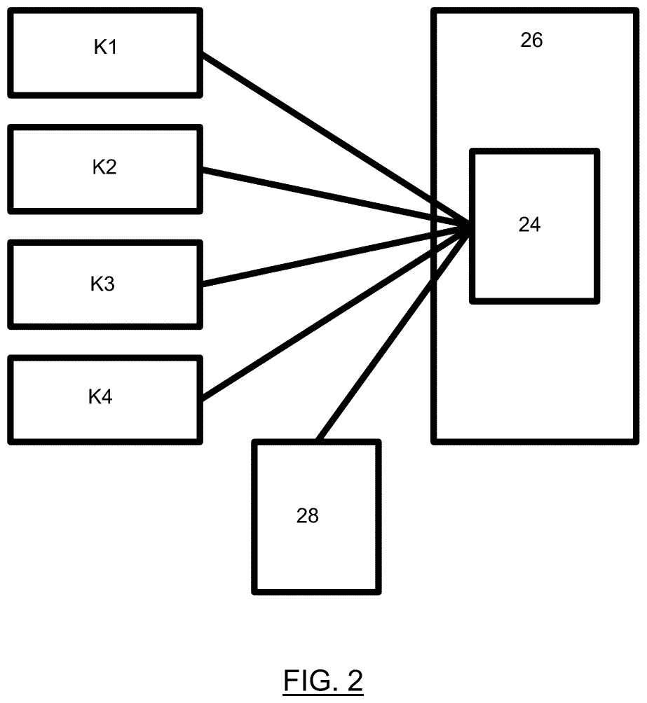

FIG. 2 is a schematic view of data interfaces of a production plant by way of example.

In FIG. 1, a production plant according to the invention is generally designated by the reference sign 10. The production plant 10 comprises a first functional unit F1, a second functional unit F2, and a third functional unit F3. The first functional unit F1 has working elements 12 and 14 arranged in a work zone A1. The first functional unit F1 is assigned a camera K1, which can detect the work zone A1 or the elements 12 and 14, at least for the most part, and generate corresponding image data.

In order to be able to concentrate or focus the image data, generated by a camera, upon production-essential aspects, portions of the corresponding work zone(s) and/or the elements arranged in this functional unit can remain outside the detection region of the camera—for example, holders of the elements, displaceable elements in their parked positions, and the like.

In a manner analogous to the first functional unit F1, the second functional unit F2 has a work zone A2, elements 16 and 18 arranged therein, and a camera K2, and the third functional unit F3 has a work zone A2, elements 20 and 22 arranged therein, and a camera K3.

In a possible embodiment of the production plant 10 shown schematically in FIG. 1, the element 12 is designed to produce packagings from flat cardboard blanks which enter the production plant 10 along the arrow P shown at the top right in FIG. 1, wherein it is possible for the element 14 arranged in the same work zone A1 to be a gantry folding head in order to bring the packages into their desired shape. A grouping is subsequently carried out in element 16, wherein the cardboard packagings subsequently are transferred from the work zone A2 into the work zone A3 via the element 18. By means of the element 20, the finished production goods, which have been manufactured by means of the production plant 10, are transported away from the production plant 10 according to the arrow P shown at the bottom left in FIG. 1, wherein it is possible for the production goods to be rotated, during their removal via the element 20, by means of the element 22, which is designed here as a gantry rotary head.

Furthermore, it can be seen in FIG. 1 that the camera K2 is not restricted to a visual range limited to the second functional unit F2, but, rather, has a detection region which extends into the adjacent first functional unit F1.

Of course, the detection regions of at least two cameras could also be designed to overlap, such that image data from different cameras could be provided to portions of the production plant 10 which are arranged in such overlapping regions.

FIG. 2 shows a communicative connection by way of example. The cameras K1-K4, shown on the left in FIG. 2, are each connected to a switch 24, which is arranged here in a switch cabinet 26. Furthermore, a touchscreen 28 is connected to the switch 24. The touchscreen 28 is in communicative connection with software which is configured to carry out the method according to the invention, and with visualization software which is configured to display corresponding image data of the cameras K1-K4 on the touchscreen 28. Furthermore, the switch 24 is in communicative connection with general control software of the production plant 10, such that the control system of the production plant 10 can be accessed via the touchscreen 28, for example.

Here, the touchscreen 28 can also function, e.g., in combination with the switch 24 and the control software of the production plant 10, as a control unit according to the present invention. Alternatively, an additional control unit can be provided which is configured to detect a signal of at least one error detection unit (see further below) which is assigned to a respective one of the elements 12-22, and to detect, based thereon, whether an error has occurred in the production plant 10. The control unit can also be connected to the switch 24.

By way of example, FIG. 1 schematically shows, on element 22, an error detection unit 30 which is designed here as a light barrier and is configured to detect whether or not production goods of predetermined dimensions pass through the light barrier. Should the detection of the light barrier deviate from predetermined expectations, an error signal is output to the control unit mentioned above, and the method according to the invention is executed.

1. A method, comprising:
providing a plurality of image acquisition units and a plurality of error detection units at a production plant, wherein the production plant comprises a plurality of work zones, wherein each of the work zones is assigned at least one of the image acquisition units and at least one of the error detection units;
configuring a control unit to detect a signal of at least one of the error detection units and based on detection of the signal to detect whether an error in the production plant has occurred in the work zone to which the error detection unit is assigned; and
in response to detection of the error in the work zone, providing image data detected by an image acquisition unit assigned to the work zone to a user via an output unit.

2. The method of claim 1 wherein, the image data acquired by the image acquisition unit are stored in a circular buffer, wherein the image data in the circular buffer are overwritten by new image data after a predetermined time period has elapsed.

3. The method of claim 2, wherein the predetermined time period is at most approximately 1 hour.

4. The method of claim 2, wherein the image data provided via the output unit to the user comprise the image data which have been recorded during the predetermined time period before the time at which the error in the work zone was detected.

5. The method of claim 4, wherein:
a first portion of the image data are provided via the output unit to the user without user input, wherein the first portion of the image data comprise the image data recorded during a first portion of the predetermined time period before the time at which the error in the work zone was detected; and
wherein a second portion of the image data are provided to the output unit in response to input by a user, wherein the second portion of the image data comprise the image data recorded during a second portion of the predetermined time period before the time at which the error in the work zone was detected; and
wherein the second portion of the predetermined time period is longer than the first portion of the predetermined time period.

6. The method of claim 1, wherein an identification of the work zone in which the error has occurred is provided with the image data via the output unit to the user.

7. The method of claim 1, wherein each image acquisition unit and each work zone is assigned its own unique identifier, and the unique identifier of the work zone in which the error has occurred and the respective unique identifier of each image acquisition unit assigned to the work zone are provided to the user via the output unit.

8. The method of claim 1, wherein the image data provided via the output unit to the user in the event of the error are transmitted to a memory unit from which the image data can be permanently retrieved.

9. The method claim 1, wherein the control unit is assigned a database in which predefined error texts are stored, and wherein the predefined error texts are assigned to at least one error type.

10. A production plant comprising:
a plurality of image acquisition units and a plurality of error detection units, wherein the production plant comprises a plurality of work zones, each of which are assigned at least one of the image acquisition units and at least one of the error detection units; and
a control unit is configured to detect a signal of at least one error detection unit and, based on the detection, detect whether an error in the production plant has occurred in the work zone to which the error detection unit is assigned,
wherein the control unit is further configured, to respond to the error being detected in the work zone by providing image data detected by at least one image acquisition unit assigned to the work zone to a user via an output unit.

11. The production plant of claim 10, wherein the output unit is located at the production plant.

12. The production plant of claim 10, wherein the output unit is further configured to receive user inputs.

13. The production plant of claim 10, wherein the production plant comprises functional units which can be at least one of mechanically connected or electrically connected to one another, and wherein each functional unit is assigned exactly one work zone.

14. The production plant of claim 13, wherein each functional unit is provided with a unique identifier and the unique identifier of the functional unit assigned to the work zone in which an error has been detected is output together with the image data to the user via the output unit.

15. The production plant of claim 10, wherein the error detection unit comprises at least one of a light barrier, a pressure sensor, a current acquisition unit, or a magnetic field unit.

16. The method of claim 2, wherein the predetermined time period is at most approximately 15 minutes.

17. The method of claim 2, wherein the predetermined time period is approximately 5 minutes.

18. The method of claim 5, wherein the image data provided via the output unit comprise the data recorded approximately 0.5 minutes before the time at which the error in the work zone was detected.

19. The method of claim 4, wherein image data recorded more than approximately 0.3 minutes to approximately 1.5 minutes before the time the error in the work zone was detected are provided via the output unit following input by a user.

20. The method of claim 19, wherein the image data provided via the output unit following input by a user are recorded more than approximately 0.5 minutes before the time the error in the work zone was detected.
